(19) United States
(12) Patent Application Publication
(10) Pub. No.: US 2007/0240660 A1
(43) Pub. Date: Oct. 18, 2007

(54) Method for Igniting Combustion of Fuel in a Combustion Chamber of an Engine, Associated Device and Engine

(76) Inventors: Volker Gallatz, Herrenberg (DE); Nikita Hirsch, Stuttgart (DE); Irina Tarasova, Ekaterinburg (RU)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/580,196

(22) PCT Filed: Nov. 26, 2004
(86) PCT No.: PCT/EP04/13421

§ 371 Date: Jan. 24, 2007

(30) Foreign Application Priority Data
Dec. 1, 2003 (DE) 10356916.2

(51) Int. Cl. F02P 23/00

(52) U.S. Cl. 123/143 B

(57) ABSTRACT

The invention relates to a method which is used to ignite the combustion of fuel in a combustion chamber (5) of a engine (2), by introducing microwave radiation into the combustion chamber (5), said microwave radiation being produced in a microwave source (7) on the outside of the combustion chamber (5). The introduced microwave radiation is absorbed by the fuel distributed in the combustion chamber (5). The supply of energy, in the fuel, arising from absorption, distributed combustion in a large-volume in the combustion chamber (5), preferably in the entire combustion chamber (5) and in a homogeneous manner, and is essentially simultaneously ignited. The invention also relates to an associated ignition device (1) and an associated engine (2).

The invention relates to a process for igniting the combustion of fuel in the combustion chamber or combustion space of an engine and an associated ignition device and an associated engine.

Because the ignition process has a considerable effect on the efficiency of an internal combustion engine, and especially at a given engine output also largely determines the fuel consumption and pollutant emission, in the past extensive efforts have been made to optimize the ignition process. The currently most common ignition devices use spark plugs which ignite the fuel-air mixture. These spark plugs can have one or more electrodes. Each of these electrodes produces an ignition spark which ignites the fuel-air mixture in the immediate vicinity of the electrode. Combustion begins accordingly first in a very small starting volume around the electrodes of the spark plugs. Subsequently combustion propagates with an admittedly limited velocity.

DE 195 27 873 A1 and U.S. Pat. No. 5,136,944 describe a glow plug which has a catalytic surface coating of the glow part for reducing the power consumption required for ignition. The disadvantage is that on the one hand the production costs due to the required catalyst materials are increased, and on the other the combustion process is only insignificantly optimized. U.S. Pat. No. 4,774,914 and U.S. Pat. No. 6,595,194 describe an ignition device which is designed to generate an especially large ignition spark.

U.S. Pat. No. 4,113,315 describes a two-chamber ignition process, in which the fuel-air mixture is ignited by an ignition source in a first, small ignition space and then the fuel-air mixture is ignited by the flame propagation which occurs in a larger second space, the actual cylinder. U.S. Pat. No. 4,499,872 shows a development of this two-chamber ignition process in which a mixture of ionized water and fuel is ignited using magnetic fields and ignition rods. It is common to the two-chamber ignition processes that they require high construction and thus production cost.

U.S. Pat. No. 5,673,554 and U.S. Pat. No. 5,689,949 discloses ignition processes in which microwave energy is used to produce in the combustion space a plasma which ignites the fuel-air mixture. The formation of the plasma is dependent largely on adherence to narrow boundary conditions with respect to formation of a resonant mode; this leads to considerable construction effort especially with respect to the engine pistons which move up and down. Moreover, the microwave transmitter limits the path of piston motion in the engine. The corresponding also applies to U.S. Pat. No. 5,845,480.

U.S. Pat. No. 5,983,871 describes a combination of injection of microwave and laser energy for producing the plasma. In this way the complexity of the ignition device and of the ignition process as well as the pertinent engine are further increased. The corresponding applies to U.S. Pat. No. 6,581,581 which describes a combination of ignition by microwave plasma and magnetic ionization of the atomized fuel-air mixture.

It is common to the known processes that they require complex and thus expensive and high-maintenance structures and moreover have only a limited service life. The efficiency of the combustion process and therefore of the engine driven by it are moreover limited. In addition, the emission of pollutants is not adequately reduced. In particular a lower combustion temperature is achieved by the leaning of the fuel-air mixture which has taken place for purposes of reduction of the fuel consumption; this entails less power. The lower combustion temperature moreover leads to increased pollutant emission.

Therefore the object of the invention is to make available a process for ignition of the combustion of fuel in the combustion space of an engine and the pertinent ignition device and the pertinent engine which overcome the disadvantages of the prior art. In particular, ignition will take place as claimed in the invention such that the combustion characteristic is optimized, especially reduced fuel consumption and reduced pollutant emission at a given power.

The object is achieved by the process defined in claim 1 and by the device and engine defined in the subordinate claims. Special data for implementation of the invention are defined in the dependent claims.

The invention relates especially to a process of ignition of combustion of fuel in the combustion space of an engine by injecting into the combustion space microwave radiation produced in a microwave source outside of the combustion space, the injected microwave radiation being absorbed by the fuel distributed in the combustion space, and due to the energy delivery into the fuel which occurs due to absorption, the combustion being uniformly distributed preferably over a large volume in the combustion space and being ignited essentially at the same time, preferably being uniformly distributed in the entire combustion space and being ignited essentially at the same time.

Generally, in the combustion space there is a mixture of fuel and an oxygen source, for example a fuel-air mixture. By moving the piston in the cylinder the fuel-air mixture is moreover often compressed during the ignition process. The injection of microwave radiation takes place preferably such that an energy density distribution as homogeneous as possible is formed in the combustion space. For this purpose, either the microwave window can have a comparatively large area or a small-area microwave window can be used. In the latter case, it can be advantageous to provide a diffusion means at the entry point of the microwave radiation into the generally cylindrical combustion space, for example a suitable flat, point, line or grid structure which causes radiation of microwaves into the combustion space with an isotropic directional characteristic. Optionally a definable energy density distribution in the combustion space can be achieved by the configuration of the diffuser.

The wavelength of the microwaves is preferably between 0.1 cm and 45 cm, especially between 1 cm and 15 cm and typically between 3 cm and 10 cm. In one preferred embodiment of the invention, the microwaves are injected in pulse form, and for this purpose one or more microwave pulses can be used. The power of the microwave pulses depends on the respective application and can be for example between one kilowatt and 70 kW. The pulse length can be for example between 1 nsec and 2 msec, the pulse distance for several microwave pulses typically being between 100 nsec and 2 msec.

The supplied microwave energy is used directly for simultaneous and uniform ignition of the entire fuel air mixture. The change of the volume of the combustion space during the pulse interval can be negligibly small due to the pulse duration which is relatively short with respect to the speed of piston motion. The power of the microwave pulses must be selected to be high enough for enough ignition energy to be injected into the combustion space.

The supplied microwave energy heats the fuel droplets present in the fuel-air mixture up to the ignition point and thus ignites the mixture. In contrast to the prior art, in this invention the production of a plasma is avoided.

In contrast to the known ignition systems, in this invention ignition takes place not at a single given site in the combustion space and therefore need not then propagate comparatively slowly, but preferably the entire fuel-air mixture is ignited almost simultaneously and uniformly in the entire combustion space.

In the known ignition process the combustion process of the fuel-air mixture in the internal combustion engine proceeds in two phases; in the first, comparatively slow, so-called laminar phase, the laminar flame velocity essentially limits the speed of the engine combustion process and thus the efficiency. Typical laminar flame velocities especially of modern internal combustion engines with leaned mixture compositions are roughly 10 cm/sec. The laminar phase is followed by the so-called turbulent combustion phase. From the standpoint of efficiency as high as possible, the second turbulent combustion phase should always be reached as quickly as possible. This is also the focus of some efforts from the prior art, in which as before the first phase must proceed to reach the second phase.

In contrast, according to this invention the first, slow laminar combustion phase is completely skipped and ignition leads directly to the second, high-speed turbulent combustion phase.

The invention also relates to an ignition device for executing the process as claimed in the invention. The electrical power supply source is preferably a pulsed high voltage power pack which makes available the energy required for the microwave pulses. The microwave source can be for example a magnetron, klystron, gyrotron, travelling wave tube, (TWT) or the like. Possible microwave connections must be adapted to the wavelength of the microwave source with respect to their dimensions in order to keep reflections and power losses as small as possible. If necessary the microwave line can also be made flexible.

In one preferred embodiment of the invention, between the microwave source and the microwave window there is a coupling means, which on the one hand transmits the microwaves sent by the microwave source to the microwave window, but which on the other hand does not transmit the microwaves reflected by the combustion space back into the microwave source. In particular, this coupling means can have a triple port, especially a circulator with a microwave source connected to its first port, a microwave window connected to its second port and a preferably passive microwave consumer connected to its third port. The circulator has the function of relaying microwave energy from the microwave source to the combustion space and at the same time diverting the microwave energy radiated back by the combustion space to the passive microwave consumer which absorbs the microwave energy reflected by the combustion space. In this way, the microwave source is protected against reflected microwave radiation. The circulator can contain a gas-filled discharger to improve the function of reducing the microwave energy which has been radiated back.

The microwave window is essentially transparent to microwave energy, in particular high microwave power can also be transported through, and on the other hand it seals the combustion space to the outside. One possible embodiment of the microwave window consists in a ceramic disk, a sapphire glass disk or a disk of another suitable material. The microwave window can moreover for example have two-dimensional or even three-dimensional structures, preferably on the surface, for example by application of a metallic structure by which a definable emission characteristic of microwave energy into the combustion space is ensured.

The invention also relates to an engine with an ignition device which operates according to the ignition process as claimed in the invention. One special version is an Otto engine, Wankel engine, SIDI (spark ignition direct injection) engine or diesel engine in which a fuel-air mixture in the combustion space is ignited.

This invention leads to optimum combustion of the fuel-air mixture in an engine as claimed in the invention in that in the entire combustion space by the simultaneous and uniform ignition and combustion of the fuel-air mixture a first, slow laminar combustion phase is not formed, but the second, high-speed turbulent combustion phase is started directly upon combustion. For this purpose, throughout the combustion, space small, turbulent ignition and combustion zones which propagate independently of one another are produced almost simultaneously in a very large number. Accordingly the fuel-air mixture in the entire combustion space is ignited almost at the same time and then burned.

By using several microwave pulses the fuel droplets present in the fuel-air mixture are heated gradually until the ignition temperature is reached. In this way basically unwanted different temperature regions in the combustion space are avoided since the gradual increase of the temperature leads to a more uniform and thus ultimately practically simultaneous and uniform ignition of the entire mixture in the combustion space. Moreover, basically likewise unwanted plasma generation is prevented by the repeated pulses.

Other advantages, features and details of the invention will become apparent from the dependent claims and the following description in which several exemplary embodiments are detailed with reference to the drawings. In this connection the features mentioned in the claims and in the specification can each be critical to the invention individually for themselves or in any combination.

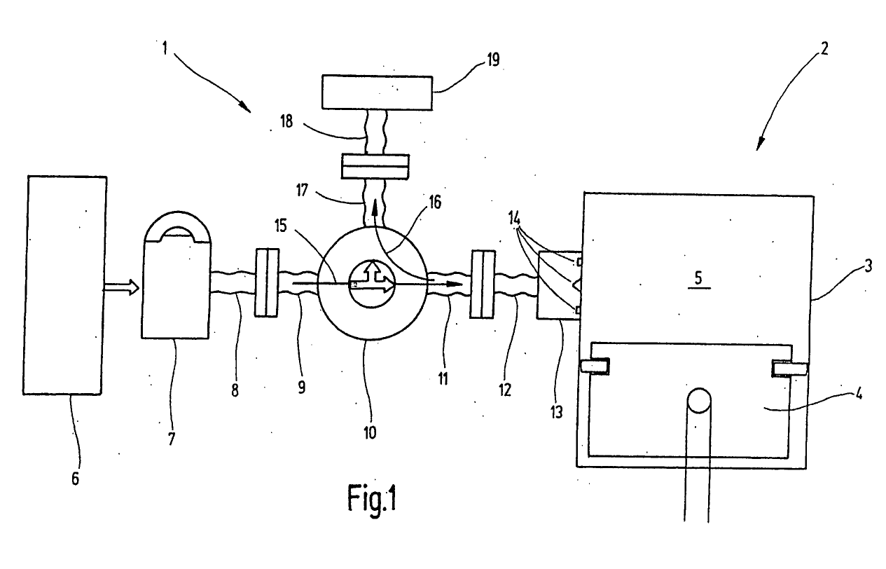

FIG. 1 schematically shows the structure of an ignition device as claimed in the invention,

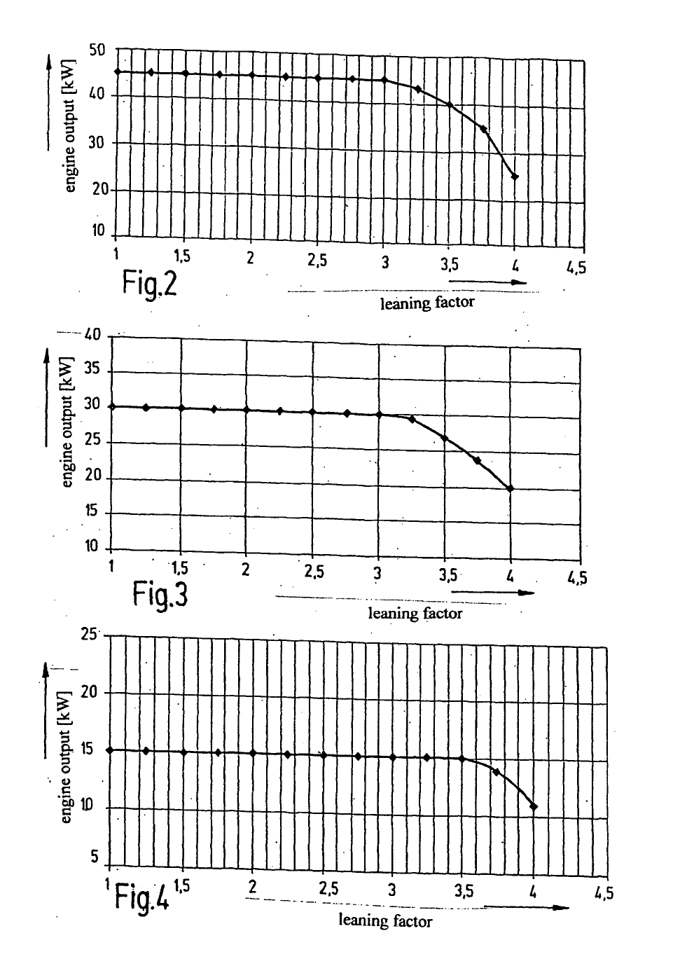

FIGS. 2 to 4 show the output of the engine as a function of the reduction in the amount of fuel in the fuel-air mixture (leaning) and

FIG. 5 shows the CO content of the engine as a function of the leaning.

FIG. 1 schematically shows the structure of an ignition device as claimed in the invention 1 for a likewise only schematically shown engine 2, of which only the cylinder 3 and the piston 4 which moves up and down in it are shown. The piston 4 and the cylinder 3 border the combustion space 5 in which ideally there is a fuel-air mixture uniformly distributed. In FIG. 1 the piston 4 is roughly at top dead center.

The ignition device 1 comprises first of all a pulsed high voltage power pack 6 with energy which drives the microwave source 7. A first piece of preferably flexible microwave line 8 is connected in the manner of a flange to a first connecting flange 9 of the circulator 10. On the side opposite the first connecting flange 9 the circulator 10 has a second connecting flange 11 which is connected in the manner of a flange to a second microwave line 12 which likewise is preferably flexible and leads to the microwave window 13.

The microwave window 13 is fixed on the jacket surface of the cylinder 3 such that the microwaves are radiated into the combustion space 5 such that the energy density distribution in the combustion space 5 is as uniform as possible. In one preferred embodiment, the microwave window 13 consists of a ceramic disk which is inserted in the cylinder 3 such that the combustion space 5 is sealed to the outside. The microwave window 13 can have on its side facing the combustion space 5 structures 14 by which a diffuse incident radiation characteristic of the microwaves into the combustion space 5 is ensured.

The microwave energy supplied by way of the first connecting flange 9 is supplied via the second connecting flange 11 to the microwave window 13 by the circulator 10 according to the energy flow represented by the arrow 15 essentially undamped and is thus injected into the combustion space 5. Reflections which occur in the combustion space 5 can lead to re-radiation of microwave energy via the second microwave line 12 and into the second connecting flange 11. The circulator 10 in this case ensures diversion of the microwave energy according to arrow 16, specifically not back into the first connecting flange 9, but via a third connecting flange 17 to which a third microwave line 18 is connected which guides the reflected energy flow to a passive microwave consumer 19. The connecting flanges 9, 11, 17 of the circulator 10 can also be arranged symmetrically at an angular distance of 120° in contrast to the representation in FIG. 1.

The ignition process as claimed in the invention was tested with an ignition device as claimed in the invention on an internal combustion engine. It was a four-stroke Otto engine with four cylinders and a volume of 1300 cm³. The engine output was 63 hp/46.6 kW. In operation with a conventional ignition system the fuel consumption was roughly 6.5 liters per 100 km.

In this series production engine the spark plugs were removed and ceramic disks used in their place as seals and as a microwave window. The structure of the ignition device 1 corresponded to that of FIG. 1. The internal combustion engine was mechanically connected to an electric generator, so that it was possible to determine the engine output. An ohmic consumer which was located in a water calorimeter was connected to the generator.

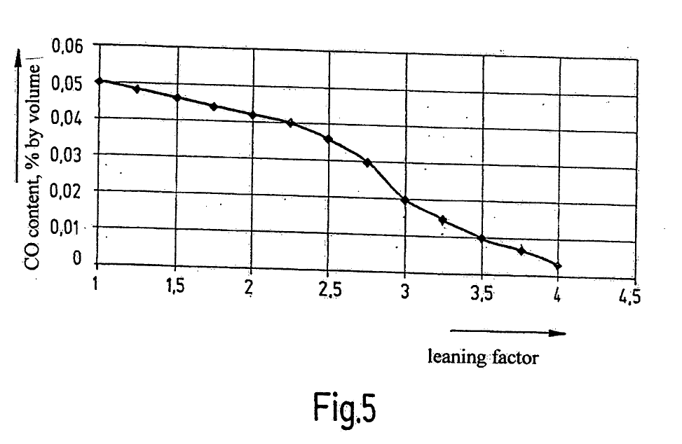

FIGS. 2 to 4 show the output of the engine as a function of the reduction of the amount of fuel in the fuel-air mixture (leaning) in three different operating ranges, specifically at full load (FIG. 2), half load (FIG. 3) and one-third load (FIG. 4). The leaning factor is defined as the fraction to which the fuel portion has been reduced, in FIGS. 2 to 4 proceeding from 1/1 to 1/4.5-th. Here it is apparent that in operation with the ignition device as claimed in the invention the fuel portion in the mixture itself under full load can be leaned by a factor of 3 without the power being reduced; at one-third load this factor is even 3.5.

FIG. 5 shows the reduction of carbon monoxide (CO) content in the exhaust gases of the engine as claimed in the invention as a function of the fuel concentration in the fuel-air mixture. Even at a factor of 1 the concentration of CO with 0.05% by volume is clearly less than in a standard engine with a conventional ignition device, where this value is roughly 0.20% by volume. For leaning by a factor of 3 the CO content can be reduced even more, down to 0.02% by volume. This means a reduction of the CO release by a factor of 10. For approximately the same output the consumption with the ignition process as claimed in the invention was only 2.3 liters of gasoline per 100 km, therefore roughly one third of the consumption with a conventional ignition process.

1. Process for ignition of combustion of fuel in the combustion space (5) of an engine (2) by injecting into the combustion space (5) microwave radiation produced in a microwave source (7) outside of the combustion space, the injected microwave radiation being absorbed by the fuel distributed in the combustion space (5), and due to the energy delivery into the fuel which occurs due to absorption the combustion being ignited essentially at the same time, distributed over a large volume in the combustion space (5), preferably uniformly distributed in the entire combustion space (5).

2. Process as claimed in claim 1, wherein the microwave radiation is injected in the form of one or more microwave pulses of short time duration and high energy.

3. Process as claimed in claim 2, wherein the number of microwave pulses and/or their power and/or their pulse duration and/or their instant is controlled depending on the operating state of the engine (2) and the power demand on the engine (2).

4. Process as claimed in claim 2, wherein preferably 1 to 10 microwave pulses, especially 1 to 5 microwave pulses, are used, preferably with a power between 1 kW and 70 kW, a pulse duration between 1 ns and 2 ms, and a pulse spacing between 100 ns and 2 ms.

5. Process as claimed in claim 2, wherein for the ignition process several microwave pulses with preferably different power and/or pulse duration are injected and guarantee leveling of the temperature increase of the fuel distributed in the combustion space up to the ignition temperature by gradual delivery of energy.

6. Process as claimed in claim 1, wherein the formation of a plasma in the combustion space (5) is prevented by the choice of the time interval of injection of microwave radiation, its power and optionally the pulse duration and pulse spacing.

7. Device (1) for igniting the combustion of fuel in the combustion space (5) of an engine (2), the device (1) having a microwave source (7) located outside of the combustion space (5) and a microwave window (13) connected to the microwave source (7), and the microwave radiation can be injected into the combustion space (5) by way of the microwave window (13) so that the injected microwave radiation can be absorbed by the fuel distributed in the combustion space (5), and due to the energy delivery into the fuel which occurs due to absorption combustion can be ignited essentially simultaneously, distributed over a large volume in the combustion space (5), preferably uniformly distributed in the entire combustion space (5).

8. Device (1) as claimed in claim 7, wherein the microwave source (7) is supplied by an electric power supply source (6) which delivers electrical pulses which can be converted into microwave pulses by the microwave source (7).

9. Device (1) as claimed in claim 7, wherein between the microwave source (7) and the microwave window (13), preferably over the course of the microwave line (8, 12), there is a coupling means (10) which transmits the microwaves sent from the microwave source (7) to the microwave window (13), but which does not transmit the microwaves reflected by the combustion space (5) back into the microwave source (7).

10. Device (1) as claimed in claim 9, wherein the coupling means (10) has a triple port, especially a circulator (10) with a microwave source (7) connected to its first port, a microwave window (13) connected to its second port, and a preferably passive microwave consumer (19) connected to its third port.

11. Device as claimed in claim 7, wherein the microwave window (13) has a ceramic material or consists completely of a ceramic material.

12. Device as claimed in claim 7, wherein the microwave source (7) is connected to the microwave window (13) by a preferably flexible microwave line (8, 12).

13. Engine (2) with a device (1) as claimed in claims 7 for ignition of the combustion of fuel in the combustion space (5) of an engine (2).

14. Engine (2) as claimed in claim 13, wherein it is an Otto engine, a Wankel engine, SIDI (spark ignition direct injection) engine or diesel engine and wherein a fuel-air mixture is ignited in the combustion space (5).
